(19) United States
(12) Patent Application Publication
(10) Pub. No.: US 2012/0222947 A1
(43) Pub. Date: Sep. 6, 2012

(54) Keypad structure and method of fabricating the same

(76) Inventor: Hsin-Chung Chang, Taoyuan (TW)

(21) Appl. No.: 13/155,395

(22) Filed: Jun. 8, 2011

(30) Foreign Application Priority Data
Mar. 1, 2011 (TW) 100106654
Mar. 1, 2011 (TW) 100203551

(51) Int. Cl. H01H 13/14; H01H 11/00

(52) U.S. Cl. 200/517; 216/39

(57) ABSTRACT

A keypad structure and method of fabricating the keypad structure are disclosed, in which, an edge of a hollowed pattern of a light-shielding color layer and an edge of a hollowed pattern of a keycap color layer are allowed to be aligned with each other, to prevent the keypad pattern from suffering a halo issue.

### BACKGROUND OF THE INVENTION

1. Field of the Invention

The present invention relates to a keypad structure and a method of fabricating the same, and particularly to a keypad structure having key legends (including letters, characters, symbols or patterns, figures, drawings) and a method of fabricating such keypad structure including steps of forming the legends.

2. Description of the Prior Art

Electronic products such as telephones, cell phones, smart phones, personal digital assistants (PDAs), electronic translators and the like usually include keypad structures. FIG. 1 illustrates a schematic cross-sectional view of a conventional structure for a key legend of a keypad. In FIG. 1, the keypad has a light color. A white print layer 4 is formed on a transparent polycarbonate (PC) film 2. When the white print layer 4 is printed on the PC film 2, it gets a hallowed pattern for key legend. Because white color has relatively low shielding properties, it is required to print a shielding ink layer, such as silver light-shielding layer 6, on the white color layer. The silver light-shielding layer also has a hallowed pattern for key legend corresponding to the white print layer 4. Thereafter, a gray transparent layer 8 is formed, which provides a surface color of the key legend. However, since the key legend has a fine patter and there is often an alignment error occurred to two or more steps of color printing, the line width of the hallowed pattern of the silver light-shielding layer 6 is often allowed to be greater than that of the hallowed pattern of the white print layer 4. As shown in FIG. 1, these two patterns are overlapped but with a distance, d, between the edges. Generally, the distance, d, may be for example about 0.25 mm.

However, the light shielding is poor for the area between the two edges of these two color layer, resulting in a light-penetration (halo) issue. As shown in FIG. 2, when a user looks at the surface of the PC film 2, a weak light beam emitted through a halo region 9 is also perceived in addition to the light beam emitted through a hallowed pattern 7 from a backlight, resulting in a less exquisite key legend figure.

JP 2007-73463A discloses a push-button switch, in which a keycap body is made of resin and a coating layer laminating a first resin thin-film layer, an inorganic coating layer, and a transparent second resin thin-film layer in order from the surface side of the keycap body on the top face of the keycap body. The inorganic coating layer is covered by the resin thin-film, and accordingly erosion, toxic or allergic problems caused by the inorganic substance can be avoided.

JP 2006-59677A teaches a screen-printing method to form an expressing color layer on a keycap surface or beneath a transparent keycap by superposing three different gray-tone color layers to allow the keytop to have a color in gradation.

Therefore, there is still a need for a novel keypad structure or a novel method of fabricating the same to solve the halo issue.

### SUMMARY OF THE INVENTION

One object of the present invention is to provide a method of fabricating a keypad structure and a keypad structure, to prevent from a halo issue suffered by conventional key legends as aforesaid.

According to one embodiment of the present invention, a method of fabricating a keypad structure is provided. The method includes steps as follows. A keycap component is formed, which includes steps as follows. A laminate is provided. The laminate includes a transparent plastic layer, a keytop base color layer and a light-shielding color layer. The keytop base color layer is between the transparent plastic layer and the light-shielding color layer, the transparent plastic layer is between the keytop base color layer and the light-shielding color layer, or the light-shielding color layer is between the keytop base color layer and the transparent plastic layer. The light-shielding color layer and the keytop base color layer are partially removed, to form a first hollowed pattern on the light-shielding color layer and a second hollowed pattern on the keytop base color layer. An edge of the first hollowed pattern and an edge of the second hollowed pattern are aligned with each other. The laminate is formed into a keycap-shaped shell and the keycap-shaped shell is filled with a keycap material, or a keycap-shaped cured-resin layer is disposed on a non-light-shielding-color-layer side of the laminate, so as to form a keycap layer. The keycap layer is cut to obtain the keycap component. The keycap component is combined with a circuit board, a metal dome and a plunger to assembly the keypad structure.

According to one embodiment of the present invention, a method of fabricating a keypad structure is provided. The method includes steps as follows. A keycap component is formed, which includes steps as followed. A transparent plastic layer is provided. A first color layer is disposed on one face of the transparent plastic layer. A second color layer is disposed on the first color layer to form a laminate. The second color layer includes a first hollowed pattern. The first color layer is partially removed through the first hollowed pattern of the second color layer to form a second hollowed pattern on the first color layer. An edge of the first hollowed pattern and an edge of the second hollowed pattern are formed to be aligned with each other. The laminate is formed into a keycap-shaped shell and the keycap-shaped shell is filled with a keycap material, or a keycap-shaped cured-resin layer is disposed on the transparent plastic layer of the laminate, so as to form a keycap layer. The keycap layer is cut to obtain the keycap component. The keycap component is combined with a circuit board, a metal dome and a plunger to assembly the keypad structure.

According to another embodiment of the present invention, in which, forming a keycap layer of a keycap component includes steps of disposing a keycap-shaped cured-resin layer on one face of a transparent plastic layer; disposing a keytop base color layer on another face of the transparent plastic layer; disposing a light-shielding color layer on the keytop base color layer; partially removing the light-shielding color layer and the keytop base color layer to form a first hollowed pattern on the light-shielding color layer and a second hollowed pattern on the keytop base color layer. An edge of the first hollowed pattern and an edge of the second hollowed pattern are aligned with each other.

According to further another embodiment of the present invention, in which, forming a keycap layer of a keycap component includes steps of disposing a keycap-shaped cured-resin layer on one face of a transparent plastic layer; disposing a keytop base color layer on another face of the transparent plastic layer; disposing a light-shielding color layer on the keytop base color layer, in which, the light-shielding color layer includes a first hollowed pattern; and partially removing the keytop base color layer through the first hollowed pattern to form a second hollowed pattern on the keytop base color layer. An edge of the first hollowed pattern is aligned with an edge of the second hollowed pattern.

According to still further another embodiment of the present invention, a keypad structure is provided. The keypad structure includes a circuit board, a metal dome above the circuit board, a plunger above the metal dome and a keycap component above the plunger. The keycap component includes a laminate. The laminate includes a transparent plastic layer, a keytop base color layer and a light-shielding color layer. These three layers are laminated together. The keytop base color layer includes a first hollowed pattern. The light-shielding color layer includes a second hollowed pattern. An edge of the second hollowed pattern is aligned with an edge of the first hollowed pattern. The light-shielding color layer is between the keytop base color layer and the plunger.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic cross-sectional view showing a conventional structure for a key legend of a keypad;

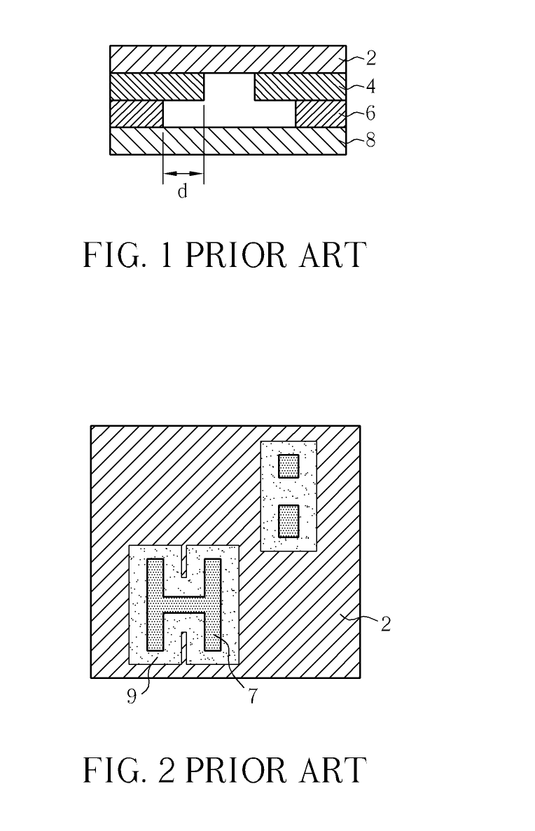

FIG. 2 is schematic diagram illustrating a halo issue suffered by a conventional key legend;

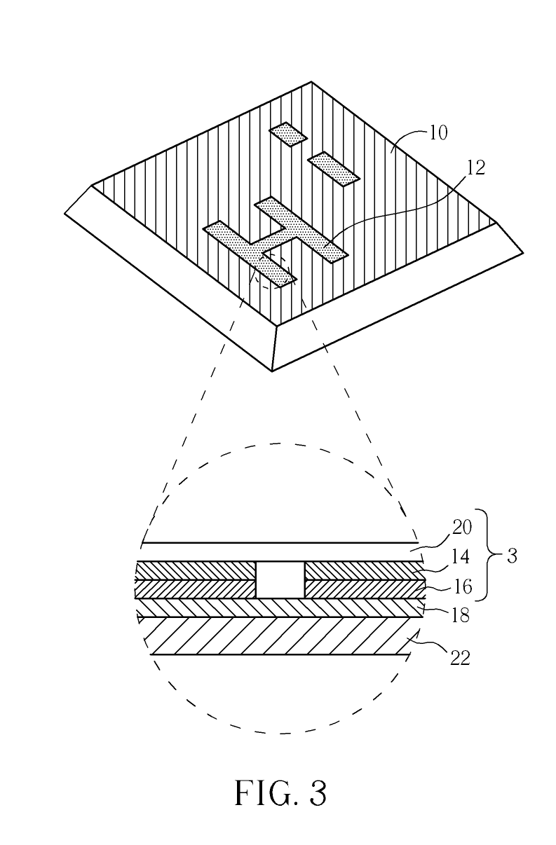

FIG. 3 is schematic diagram illustrating a feature of a structure for a key legend in an embodiment according to the present invention;

FIG. 4 is a flow chart illustrating an embodiment according to a method of fabricating a keypad structure of the present invention;

FIGS. 5 and 6 are schematic cross-sectional views illustrating an embodiment according to the method of fabricating a keypad structure of the present invention;

FIG. 7 is a schematic cross-sectional view illustrating another embodiment according to the method of fabricating a keypad structure of the present invention; and

FIGS. 8 to 10 are schematic cross-sectional views illustrating some embodiments according to the keypad structure of the present invention.

### DETAILED DESCRIPTION

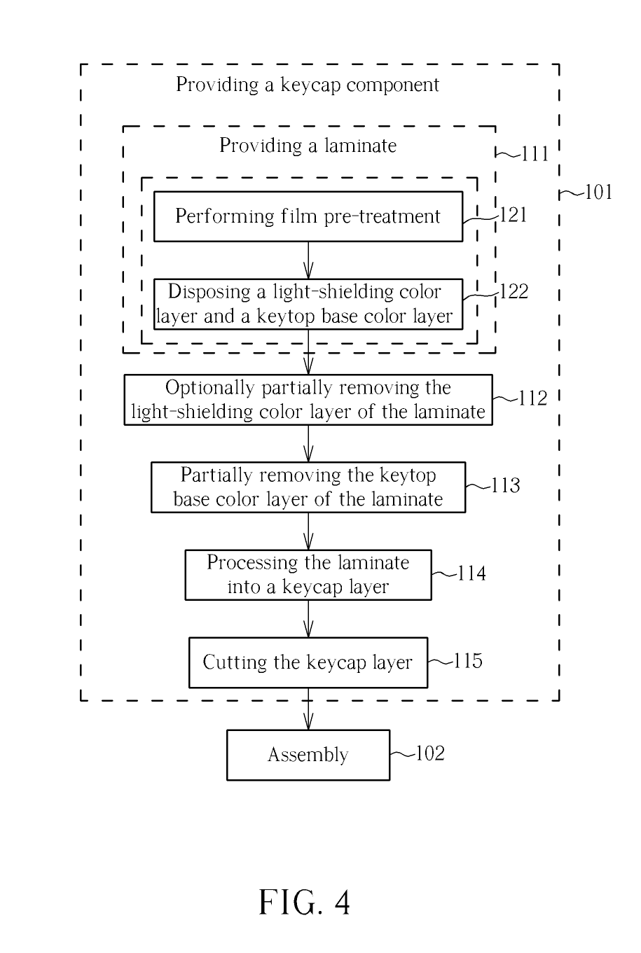

A specific feature of the key legend structure in an embodiment according to the present invention is illustrated by FIG. 3. As shown in FIG. 3, a letter structure 12 of the keycap 10 generally has a fine pattern and includes a keytop base color layer 14 and a light-shielding color layer 16, both of which have a hollowed pattern of a desired letter figure. These two hollowed patterns are stacked up and down, and the edges of these two hollowed patterns are aligned in an up-and-down direction with each other. Herein, “the two edges are aligned with each other in an up-and-down direction” may be also referred as “the two edges overlap each other in an up-and-down direction”. More specifically, the two hollowed patterns can further exactly overlap each other well. When the edges of these two hollowed patterns are formed to be aligned with each other, the shape of the letter figure expressed by the hollowed patterns with a backlight is very sharp or distinct. Accordingly, according to the spirit of the present invention, it should be construed to be within the scope of the present invention as long as at least one portion of the edge of one of these two hollowed patterns is aligned with at least one portion of the edge of another of these two hollowed patterns. In the present invention, the hollowed pattern may be for example a character, symbol, number, letter or figure, or the like. Optionally, a transparent color layer 18 may be included to allow the key legend displayed through the backlight to have a color thereof. The outmost layer of the keycap 10 of the embodiment as shown in FIG. 3 is the transparent plastic layer 20 which may serve as a carrier. The transparent plastic layer 20, the keytop base color layer 14 and the light-shielding color layer 16 may be deemed as a laminate 3. In the embodiment shown in FIG. 3, the laminate 3 and the optional transparent color layer 18 are together formed into a keycap-shaped shell, which is with a keycap body 22 together to form the keycap 10. Each of the keytop base color layer, the light-shielding color layer and the transparent color layer can be referred to as a color layer.

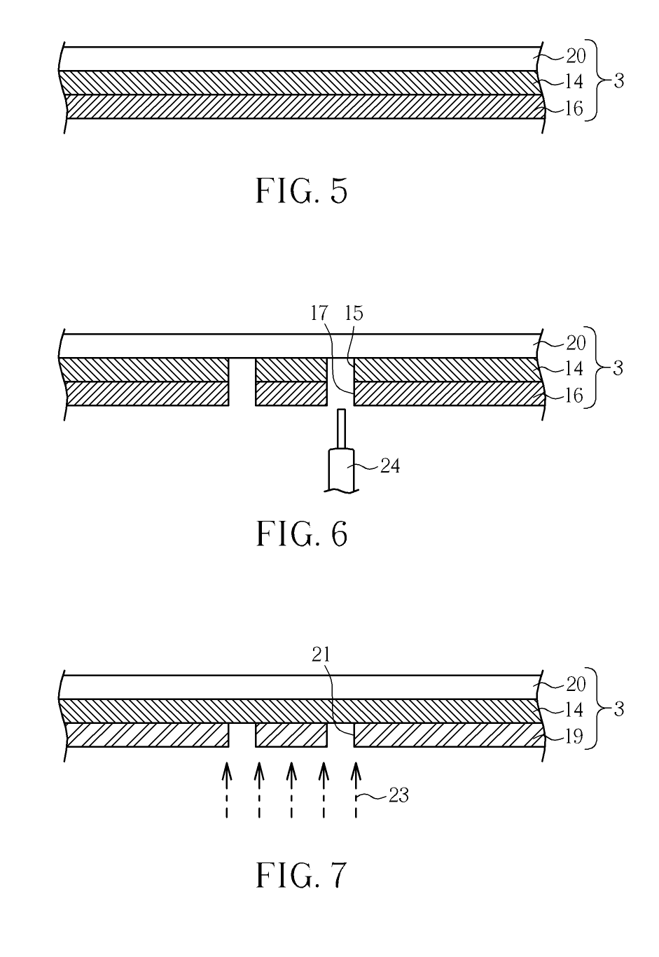

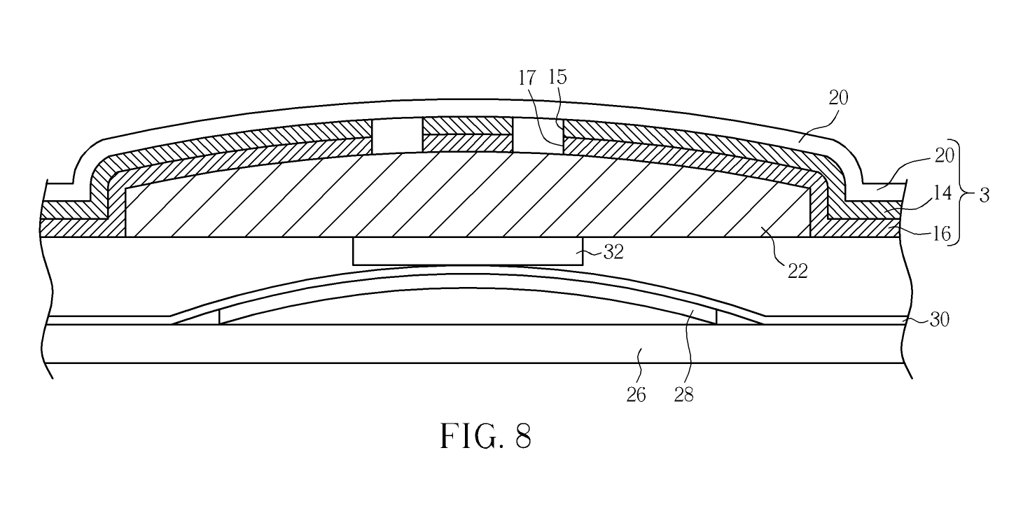

FIG. 4 is a flow chart illustrating an embodiment according to a method of fabricating a keypad structure of the present invention. Please also refer to cross-sectional views of FIGS. 5 and 6. In Step 101, a keycap component is formed. The keycap is not limited to a specific type. It may be for example a molded keycap or a dispensed-and-cured-resin keycap. The step of forming the keycap component may include for example Step 111 to provide a laminate 3 including a transparent plastic layer 20, a keytop base color layer 14 and a light-shielding color layer 16. The transparent plastic layer 20 may be for example a PC film, poly(ethylene terephthalate) (PET) film, polymethylmethacrylate (PMMA) film, or the like, but not limited thereto. The step of providing the laminate may include for example Step 121 to perform a film pre-treatment on the transparent plastic layer 20. The film pre-treatment maybe for example surface modification to improve adherence to the color layer, process to improve ductility or thickness requirement for punching, or process for forming glossy or misty surface or patterns. Thereafter, the keytop base color layer 14 and the light-shielding color layer 16 are formed on the transparent plastic layer 20. For example, Step 122 is performed to coat, spray or print the keytop base color layer 14 and the light-shielding color layer 16 on the transparent plastic layer 20. The keytop base color layer 14 and the light-shielding color layer 16 may include conventional ink layers applicable to keypad structures, but not limited thereto, as long as material is usable to serve as a color layer in the present invention. In one embodiment, the keytop base color layer 14 may be a light color layer, and the light-shielding color layer 16 may be a silver light-shielding layer.

The keytop base color layer 14 maybe formed on the transparent plastic layer 20, and then the light-shielding color layer 16 is formed on the keytop base color layer 14. Accordingly, the keytop base color layer 14 is disposed between the transparent plastic layer 20 and the light-shielding color layer 16, as shown in FIG. 5. Alternatively, the keytop base color layer 14 may be formed on one face of the transparent plastic layer 20 and the light-shielding color layer 16 is formed on another face of the transparent plastic layer 20. Accordingly, the transparent plastic layer 20 is disposed between the keytop base color layer 14 and the light-shielding color layer 16. Alternatively, the light-shielding color layer 16 maybe formed on the transparent plastic layer 20, and then the keytop base color layer 14 is formed on the light-shielding color layer 16. Accordingly, the light-shielding color layer 16 is disposed between the keytop base color layer 14 and the transparent plastic layer 20.

It is notable that the keytop base color layer 14 and the light-shielding color layer 16 are each not limited to being a full print, and they also may be a non-full print or hollowed, or they may each have a mono- or multi-color.

As shown in FIG. 5, the keytop base color layer 14 and the light-shielding color layer 16 cover the predetermined location for hollowed patterns. Accordingly, Steps 112 and 113 may be performed to partially remove the light-shielding color layer 16 and the keytop base color layer 14 in order to form a hallowed pattern 17 to the light-shielding color layer 16 and a hollowed pattern 15 to the keytop base color layer 14. The partial removal maybe accomplished through an irradiation treatment, such as laser etching (also referred to as laser engraving) using a laser 24 in the embodiment shown in FIG. 6. It is noted that the edges of these two hollowed patterns should be allowed to be aligned with each other. The edges of the hallowed patterns 15 and 17 can easily be aligned with each other when they are formed because the light-shielding color layer 16 and the underlying keytop base color layer 14 are directly etched using a laser. Aligning these two edges includes other ways in addition to laser etching. Other irradiation treatment can be used. For example, these two layers may each include light-reactive material, and, by using a mask, the place (such as a predetermined hollowed pattern) of the work piece irradiated with high-energy UV light will decompose and can be removed and the place not irradiated will be cured and can be remained; otherwise, the place (such as a non-predetermined hollowed pattern) of the work piece irradiated with high-energy UV light will be cured and can be remained and the place not irradiated will decompose and can be removed, i.e. similar to a reaction of positive or negative photo resist. Alternatively, a mechanical removing process may be utilized to form these two aligned edges. For example, a mechanical milling process may be performed on these two layers employing a milling cutter to form hollowed patterns. Alternatively, a chemical removing process may be utilized to form these two aligned edges. For example, these two layers maybe allowed to include material reactive to dry-etching, acid-etching or alkaline-etching, and they may have selectivity for partial removal by etching through a mask (protective layer).

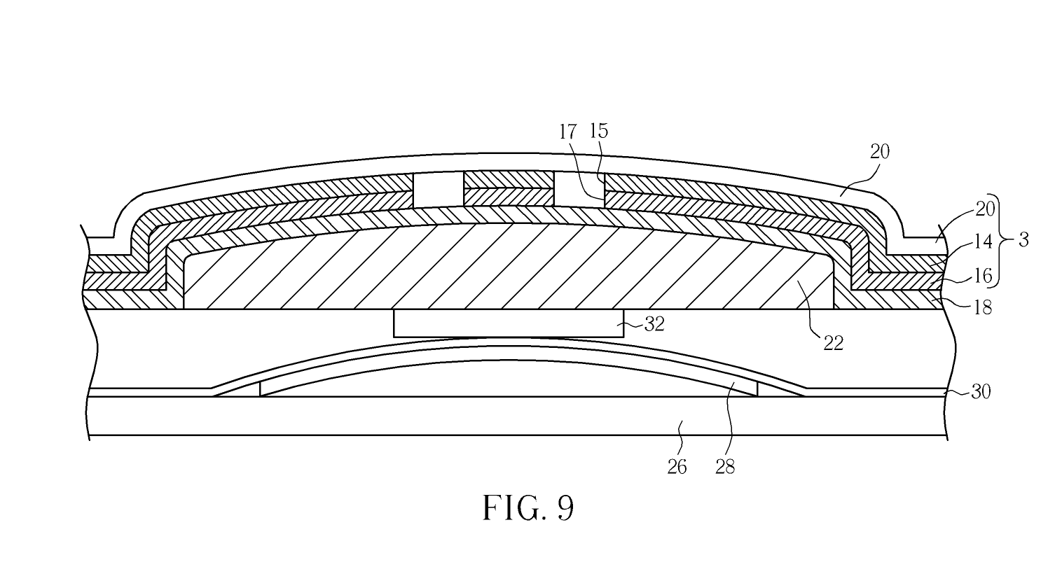

In another embodiment, as shown in FIG. 7, the light-shielding color layer 19 may be formed on the keytop base color layer 14 in a way, such as screen printing (but not limited thereto) and the light-shielding color layer 19 may have a hollowed pattern 21 when it is formed. In this situation, Step 112 is not required and only Step 113 is performed to partially remove the keytop base color layer 14 through the hollowed pattern 21 to form a hollowed pattern. In such situation, the aforesaid irradiation treatment, mechanical removing process, or chemical removing process may be utilized to partially remove the keytop base color layer 14. The light-shielding color layer 19 may serve as a mask and the keytop base color layer 14 is subjected to an irradiation reaction 23 or an etch process through the hollowed pattern 21.

Likewise, in the case that the light-shielding color layer is disposed between the keytop base color layer and the transparent plastic layer, the light-shielding color layer and the keytop base color layer may be formed as the aforesaid and have two hollowed patterns having aligned edges. In more detail, the light-shielding color layer maybe formed on the transparent plastic layer, then the keytop base color layer is formed on the light-shielding color layer, and then two hollowed patterns are formed. Alternatively, the light-shielding color layer maybe formed on the transparent plastic layer, then the keytop base color layer having a hollowed pattern is formed on the light-shielding color layer, and then a hollowed pattern is formed to the light-shielding color layer in a way as the aforesaid. However, in this situation, since the light-shielding color layer is disposed between the keytop base color layer and the transparent plastic layer, the keytop base color layer becomes the outmost layer of the keycap structure and would be probably damaged due to exposure to the environment.

In the case that the transparent plastic layer is disposed between the keytop base color layer and the light-shielding color layer, the keytop base color layer and the light-shielding color layer can be still formed to have two hollowed patterns having aligned edges. Accordingly, such structure is still within the scope of the present invention.

Furthermore, a transparent color layer may be further formed. For example, when the keytop base color layer is disposed between the transparent plastic layer and the light-shielding color layer (that is, the transparent plastic layer covers the keytop base color layer), or the transparent plastic layer is disposed between the keytop base color layer and the light-shielding color layer, a transparent color layer maybe further formed on the light-shielding color layer to cover these two hollowed patterns after they are formed. Alternatively, for example, when the light-shielding color layer is disposed between the keytop base color layer and the transparent plastic layer, a transparent color layer may be further formed on the transparent plastic layer to overlap the hollowed patterns after they are formed. In the subsequent keycap structure assembly, the transparent color layer is allowed to be between the light-shielding color layer and plungers. The transparent color layer may be formed through a full print process, and accordingly the formation is without alignment issue. Besides, the transparent color layer may be formed in accordance with the desire of aesthetic requirement, such as color matching, or function requirement. For example, the transparent color layer may be a gray transparent color layer.

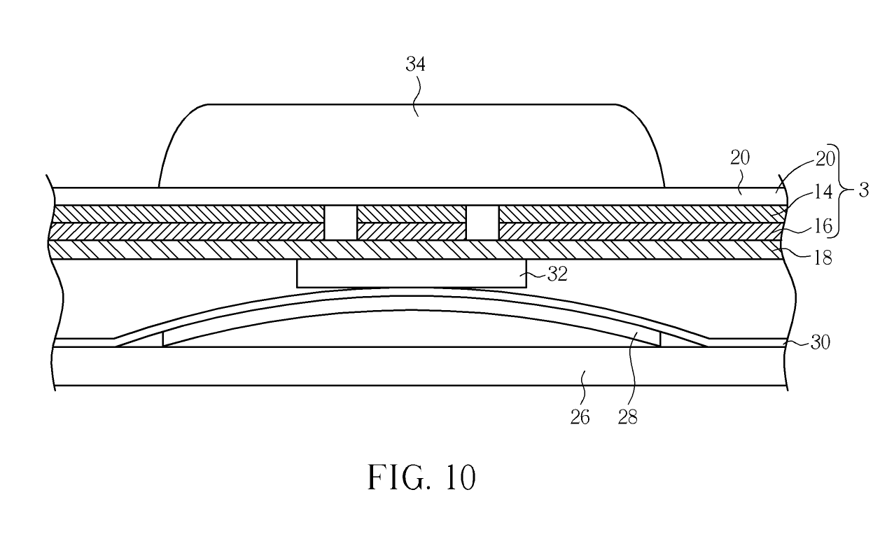

Thereafter, Step 114 is performed. Referring to FIG. 8, a laminate 3 is processed to form into a keycap layer. For example, the laminate 3 is pressed and stretched to form into a keycap-shaped shell, and a keycap material is filled into the shell to form a keycap body 22. The pressing and the stretching may be, for example, hot pressing, and may be, for example, one-sided or double-sided pressing and stretching or air pressure/die pressing and stretching. FIG. 9 shows an embodiment including a transparent color layer 18. The filling to form the keycap body may be for example injection filling or silicon rubber filling.

Alternatively, as shown in FIG. 10, the step of processing the laminate 3 to form the keycap layer may include forming a keycap-shaped cured resin layer 34 on one face of a layer which is not a light-shielding color layer, to form the keycap layer. In detail, when the keytop base color layer is disposed between the transparent plastic layer and the light-shielding color layer, that is, the transparent plastic layer covers the keytop base color layer, the keycap-shaped cured resin layer is allowed to be disposed on one face of the transparent plastic layer. In such situation, the keytop base color layer and the light-shielding color layer are on another face of the transparent plastic layer. When the transparent plastic layer is disposed between the keytop base color and the light-shielding color layer, the keycap-shaped cured resin layer is allowed to be disposed on the keytop base color layer. When the light-shielding color layer is disposed between the keytop base color layer and the transparent plastic layer, the keycap-shaped cured resin layer is allowed to be disposed on the keytop base color layer. FIG. 10 further shows a transparent color layer 18. The cured resin layer may be for example a UV light cured resin, but not limited thereto.

Thereafter, Step 115 is performed to cut the keycap layer through for example punching by a punch die or cutting by a carbon dioxide (CO₂) laser, to form a keycap component, which may be a keycap component for a single key or for a plurality of keys.

Thereafter, Step 102 is performed for combination. The keycap component and a circuit board 26, a metal dome 28, an optional dome sheet 30, and a plunger 32 are combined to assembly a keypad structure. The plunger 32 and the keycap body 22 may be alternatively monolithically formed. Alight guide plate maybe further combined. The circuit board may be flexible. When the keytop base color layer has a light color, the advantage of the present invention is more remarkable, so that the halo issue as encountered in the conventional technology can be avoided.

Furthermore, in the case that the keycap component includes keycap-shaped cured resin layer 34, a keytop base color layer and a light-shielding color layer may be formed on the transparent plastic layer, and then the keycap-shaped cured resin layer may be formed, as those steps performed in the embodiment mentioned above. Alternatively, in another embodiment, the keycap-shaped cured resin layer 34 may be formed on one face of a transparent plastic layer, such as a PET film, and then a keytop base color layer and a light-shielding color layer may be formed on another face of the transparent plastic layer in a way as mentioned above, and then steps including forming hallowed patterns and cutting are performed to obtain the keycap component. Similar to the aforesaid embodiments, the light-shielding color layer may have a hollowed pattern when it is formed, and a hollowed pattern is formed to the keytop base color layer through the hollowed pattern of the light-shielding color layer. Likewise, a transparent color layer may be further disposed on the light-shielding color layer.

Those skilled in the art will readily observe that numerous modifications and alterations of the device and method may be made while retaining the teachings of the invention.

What is claimed is:

1. A method of fabricating a keypad structure, comprising:
forming a keycap component, comprising:
providing a laminate comprising a transparent plastic layer, a keytop base color layer and a light-shielding color layer, wherein the keytop base color layer is between the transparent plastic layer and the light-shielding color layer, the transparent plastic layer is between the keytop base color layer and the light-shielding color layer, or the light-shielding color layer is between the keytop base color layer and the transparent plastic layer,
partially removing the light-shielding color layer and the keytop base color layer to form a first hollowed pattern on the light-shielding color layer and a second hollowed pattern on the keytop base color layer, wherein an edge of the first hollowed pattern is aligned with an edge of the second hollowed pattern, forming the laminate into a keycap-shaped shell and filling the keycap-shaped shell with a keycap material, or disposing a keycap-shaped cured-resin layer on a non-light-shielding-color-layer side of the laminate, to form a keycap layer, and
cutting the keycap layer to obtain the keycap component; and
combining the keycap component with a circuit board, a metal dome and a plunger to assembly the keypad structure.

2. The method of fabricating a keypad structure according to claim 1, wherein partially removing the light-shielding color layer and the keytop base color layer comprises an irradiation treatment for removal.

3. The method of fabricating a keypad structure according to claim 2, wherein the irradiation treatment for removal comprises a laser etching process.

4. The method of fabricating a keypad structure according to claim 1, wherein partially removing the light-shielding color layer and the keytop base color layer comprises a mechanical removing process.

5. The method of fabricating a keypad structure according to claim 1, wherein partially removing the light-shielding color layer and the keytop base color layer comprises a chemical removing process.

6. The method of fabricating a keypad structure according to claim 1, wherein,
the keytop base color layer is between the transparent plastic layer and the light-shielding color layer or the transparent plastic layer is between the keytop base color layer and the light-shielding color layer, and
forming the keycap component further comprises, after forming the first hollowed pattern and the second hollowed pattern, disposing a transparent color layer on the light-shielding color layer to cover the first hollowed pattern.

7. The method of fabricating a keypad structure according to claim 1, wherein,
the light-shielding color layer is between the keytop base color layer and the transparent plastic layer, and
forming the keycap component further comprises, after forming the first hollowed pattern and the second hollowed pattern, disposing a transparent color layer on the transparent plastic layer to overlap the second hollowed pattern.

8. A method of fabricating a keypad structure, comprising:
forming a keycap component, comprising:
providing a transparent plastic layer;
disposing a first color layer on one face of the transparent plastic layer;
disposing a second color layer on the first color layer to form a laminate, wherein the second color layer comprises a first hollowed pattern;
partially removing the first color layer through the first hollowed pattern of the second color layer to form a second hollowed pattern on the first color layer, wherein an edge of the first hollowed pattern is aligned with an edge of the second hollowed pattern;
forming the laminate into a keycap-shaped shell and filling the keycap-shaped shell with a keycap material, or disposing a keycap-shaped cured-resin layer on the transparent plastic layer of the laminate, to form a keycap layer; and
cutting the keycap layer to obtain the keycap component; and
combining the keycap component with a circuit board, a metal dome and a plunger to assembly the keypad structure.

9. The method of fabricating a keypad structure according to claim 8, wherein the first color layer comprises a keytop base color layer and the second color layer comprises a light-shielding color layer.

10. The method of fabricating a keypad structure according to claim 9, wherein forming the keycap component further comprises, after forming the second hollowed pattern, disposing a transparent color layer on the second color layer to cover the first hollowed pattern.

11. The method of fabricating a keypad structure according to claim 8, wherein the first color layer comprises a light-shielding color layer and the second color layer comprises a keytop base color layer.

12. The method of fabricating a keypad structure according to claim 11, wherein forming the keycap component further comprises, after forming the second hollowed pattern, disposing a transparent color layer on another face of the transparent plastic layer to overlap the second hollowed pattern.

13. The method of fabricating a keypad structure according to claim 11, wherein, before forming the first color layer, a transparent color layer is disposed on the face of the transparent plastic layer.

14. The method of fabricating a keypad structure according to claim 8, wherein partially removing the first color layer comprises an irradiation treatment for removal.

15. The method of fabricating a keypad structure according to claim 8, wherein partially removing the first color layer comprises a chemical removing process.

16. A method of fabricating a keypad structure, comprising:
forming a keycap component, comprising:
disposing a keycap-shaped cured-resin layer on one face of a transparent plastic layer;
disposing a keytop base color layer on another face of the transparent plastic layer;
disposing a light-shielding color layer on the keytop base color layer;
partially removing the light-shielding color layer and the keytop base color layer to form a first hollowed pattern on the light-shielding color layer and a second hollowed pattern on the keytop base color layer, wherein an edge of the first hollowed pattern is aligned with an edge of the second hollowed pattern, to form a keycap layer; and
cutting the keycap layer to obtain the keycap component; and
combining the keycap component with a circuit board, a metal dome and a plunger to assembly the keypad structure.

17. The method of fabricating a keypad structure according to claim 16, further comprising, after forming the first hollowed pattern and the second hollowed pattern, disposing a transparent color layer on the light-shielding color layer to cover the first hollowed pattern.

18. A method of fabricating a keypad structure, comprising:
forming a keycap component, comprising:
disposing a keycap-shaped cured-resin layer on one face of a transparent plastic layer;
disposing a keytop base color layer on another face of the transparent plastic layer;
disposing a light-shielding color layer on the keytop base color layer, wherein the light-shielding color layer comprises a first hollowed pattern;
partially removing the keytop base color layer through the first hollowed pattern to form a second hollowed pattern on the keytop base color layer, wherein an edge of the first hollowed pattern is aligned with an edge of the second hollowed pattern, to form a keycap layer; and
cutting the keycap layer to obtain the keycap component; and
combining the keycap component with a circuit board, a metal dome and a plunger to assembly the keypad structure.

19. The method of fabricating a keypad structure according to claim 18, further comprising, after forming the second hollowed pattern, disposing a transparent color layer on the light-shielding color layer to cover the first hollowed pattern.

20. A keypad structure, comprising:
a circuit board;
a metal dome above the circuit board;
a plunger above the metal dome; and
a keycap component above the plunger, wherein, the keycap component comprises a laminate, the laminate comprises a transparent plastic layer, a keytop base color layer and a light-shielding color layer laminated together, the keytop base color layer comprises a first hollowed pattern, the light-shielding color layer comprises a second hollowed pattern, an edge of the second hollowed pattern is aligned with an edge of the first hollowed pattern, and the light-shielding color layer is between the keytop base color layer and the plunger.

21. The keypad structure according to claim 20, wherein the keytop base color layer has a light color.

22. The keypad structure according to claim 20, wherein the laminate is formed into a keycap-shaped shell and the keycap component further comprises a keycap material filled within the keycap-shaped shell.

23. The keypad structure according to claim 22, wherein the transparent plastic layer covers the keytop base color layer and is between the keytop base color layer and the light-shielding color layer or between the light-shielding color layer and the plunger.

24. The keypad structure according to claim 20, wherein the keycap component further comprises a transparent color layer between the light-shielding color layer and the plunger.

25. The keypad structure according to claim 23, wherein the keycap component further comprises a transparent color layer between the light-shielding color layer and the plunger.

26. The keypad structure according to claim 20, wherein the keycap component further comprises a cured resin having a shape of a keycap disposed on one face of the transparent plastic layer and the keytop base color layer and the light-shielding color layer are disposed on another face of the transparent plastic layer.

27. The keypad structure according to claim 26, wherein the keycap component further comprises a transparent color layer between the light-shielding color layer and the plunger.
